(19) United States
(12) Patent Application Publication
(10) Pub. No.: US 2021/0382942 A1
(43) Pub. Date: Dec. 9, 2021

(54) Metadata Visualization

(71) Applicant: ADP, LLC, Roseland, NJ (US)

(72) Inventors: Ramkumar Ashok, New York, NY (US); Darshan Kapadia, New York, NY (US)

(21) Appl. No.: 16/891,715

(22) Filed: Jun. 3, 2020

(51) Int. Cl. G06F 16/904; G06F 16/901; G06F 16/28

(52) U.S. Cl. CPC G06F 16/904; G06F 16/288; G06F 16/9024

(57) ABSTRACT

A method of visualizing metadata is provided. The method comprises recursively expanding all external metadata blocks in a metadata object, wherein the external metadata blocks comprise different metadata types. All metadata blocks are then standardized, wherein the different metadata types are mapped to predefined standard metadata types. Relationship types between the metadata blocks are also standardized, wherein different relationship types are mapped to a predefined standard relationship type. A directed graph is then generated comprising a number of nodes and edges, wherein each node represents a standardized metadata block and each edge represents a standardized relationship type.

### BACKGROUND INFORMATION

### 1. Field

The present disclosure relates generally to an improved computing system, and more specifically to an improved method and system that allows different metadata types to be viewed together in the same user interface.

### 2. Background

Metadata is information about other data that describes one or more aspects of the data. Metadata allows a computer system to track and work with the data in question more easily. A metadata instance represents a set of actions that are represented by metadata blocks.

Each metadata instance and blocks have a metadata type associated with them. Each metadata type has a specified type of interface used to view and edit the metadata.

Therefore, it would be desirable to have a method and apparatus that take into account at least some of the issues discussed above, as well as other possible issues.

### SUMMARY

An illustrative embodiment provides a computer-implemented method for visualizing metadata. The method comprises recursively expanding all external metadata blocks in a metadata object, wherein the external metadata blocks comprise different metadata types. All metadata blocks are then standardized, wherein the different metadata types are mapped to predefined standard metadata types. Relationship types between the metadata blocks are also standardized, wherein different relationship types are mapped to a predefined standard relationship type. A directed graph is then generated comprising a number of nodes and edges, wherein each node represents a standardized metadata block and each edge represents a standardized relationship type.

Another illustrative embodiment provides a computer program product for visualizing metadata. The computer program product comprises a computer-readable storage medium having program instructions embodied thereon to perform the steps of: recursively expanding all external metadata blocks in a metadata object, wherein the external metadata blocks comprise different metadata types; standardizing all metadata blocks, wherein the different metadata types are mapped to predefined standard metadata types; standardizing relationship types between the metadata blocks, wherein different relationship types are mapped to a predefined standard relationship type; and generating a directed graph comprising a number of nodes and edges, wherein each node represents a standardized metadata block and each edge represents a standardized relationship type.

Another illustrative embodiment provides a system visualizing metadata. The system comprises a storage device configured to store program instructions and one or more processors operably connected to the storage device and configured to execute the program instructions to cause the system to: recursively expand all external metadata blocks in a metadata object, wherein the external metadata blocks comprise different metadata types; standardize all metadata blocks, wherein the different metadata types are mapped to predefined standard metadata types; standardize relationship types between the metadata blocks, wherein different relationship types are mapped to a predefined standard relationship type; and generate a directed graph comprising a number of nodes and edges, wherein each node represents a standardized metadata block and each edge represents a standardized relationship type.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 depicts a block diagram of a metadata visualization system in accordance with an illustrative embodiment;

FIG. 3 illustrates an example metadata object with which illustrative embodiments can be implemented;

FIG. 4 illustrates an example of complex metadata with which illustrative embodiments can be implemented;

FIG. 5 illustrates expanded external metadata blocks in accordance with an illustrative embodiment;

FIG. 6 illustrates linked metadata blocks in accordance with an illustrative embodiment;

FIG. 7 illustrates standardization of metadata blocks in accordance with an illustrative embodiment;

FIG. 8 depicts a directed graph illustrating standard metadata block types and standard relationship types in accordance with an illustrative embodiment;

FIG. 9 depicts a flowchart illustrating a process for visualizing metadata in accordance with an illustrative embodiment;

FIG. 10 depicts a flowchart illustrating a process for standardizing metadata types in accordance with an illustrative embodiment; and

FIG. 11 is an illustration of a block diagram of a data processing system in accordance with an illustrative embodiment.

### DETAILED DESCRIPTION

The illustrative embodiments recognize and take into account one or more different considerations. For example, the illustrative embodiments recognized and take into account that metadata instances comprise blocks representing actions. Each metadata instance and associated blocks have a metadata type that has a specific designer interface for viewing and editing the metadata.

The illustrative embodiments also recognize that metadata blocks of one metadata type cannot be viewed in designer interfaces designed for other metadata types, requiring developers to use multiple designer interfaces to view complex metadata flows that comprise different metadata types.

The illustrative embodiments provide a method to standardize different metadata types and metadata relationships to enable them to all be viewed in a common interface.

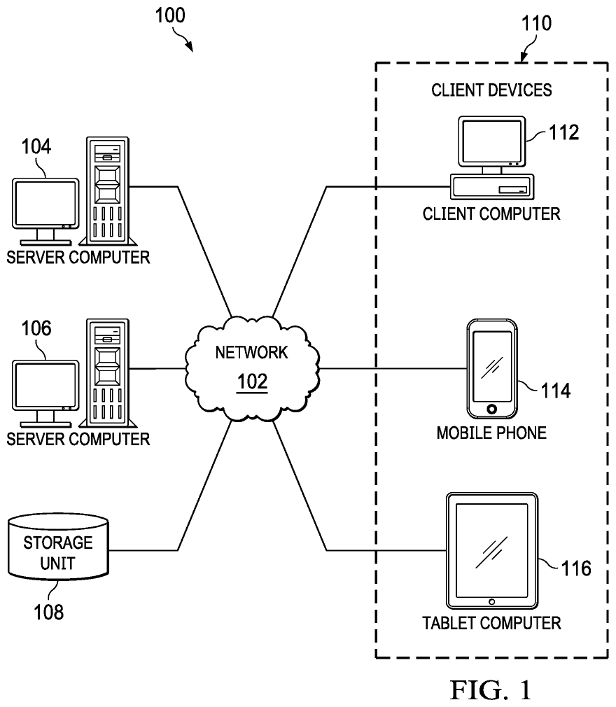

With reference now to the figures and, in particular, with reference to FIG. 1, an illustration of a diagram of a data processing environment is depicted in accordance with an illustrative embodiment. It should be appreciated that FIG. 1 is only provided as an illustration of one implementation and is not intended to imply any limitation with regard to the environments in which the different embodiments may be implemented. Many modifications to the depicted environments may be made.

The computer-readable program instructions may also be loaded onto a computer, a programmable data processing apparatus, or other device to cause a series of operational steps to be performed on the computer, a programmable apparatus, or other device to produce a computer implemented process, such that the instructions which execute on the computer, the programmable apparatus, or the other device implement the functions and/or acts specified in the flowchart and/or block diagram block or blocks.

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 might include connections, such as wire, wireless communication links, or fiber optic cables.

In the depicted example, server computer 104 and server computer 106 connect to network 102 along with storage unit 108. In addition, client devices 110 connect to network 102. In the depicted example, server computer 104 provides information, such as boot files, operating system images, and applications to client devices 110. Client devices 110 can be, for example, computers, workstations, or mobile devices. As depicted, client devices 110 include client computer 112, mobile phone 114, tablet computer 116. Other client devices might include laptop/notebook computers and smart classes.

In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 might include additional server computers, client computers, and other devices not shown. Client devices 110 might connect to network 102 utilizing at least one of wired, optical fiber, or wireless connections.

Program code located in network data processing system 100 can be stored on a computer-recordable storage medium and downloaded to a data processing system or other device for use. For example, the program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 might also be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

Illustrative embodiments can be implemented in network data processing system 100. For example, mobile phone 114 and tablet computer 116 might include an interface for mobile learning content. Mobile learning course content can be located on a server such as server computer 104 or server computer 106 or distributed across multiple serves. Communication of course content and mobile interface inputs can be communicated over network 102 with a TCP/IP protocol.

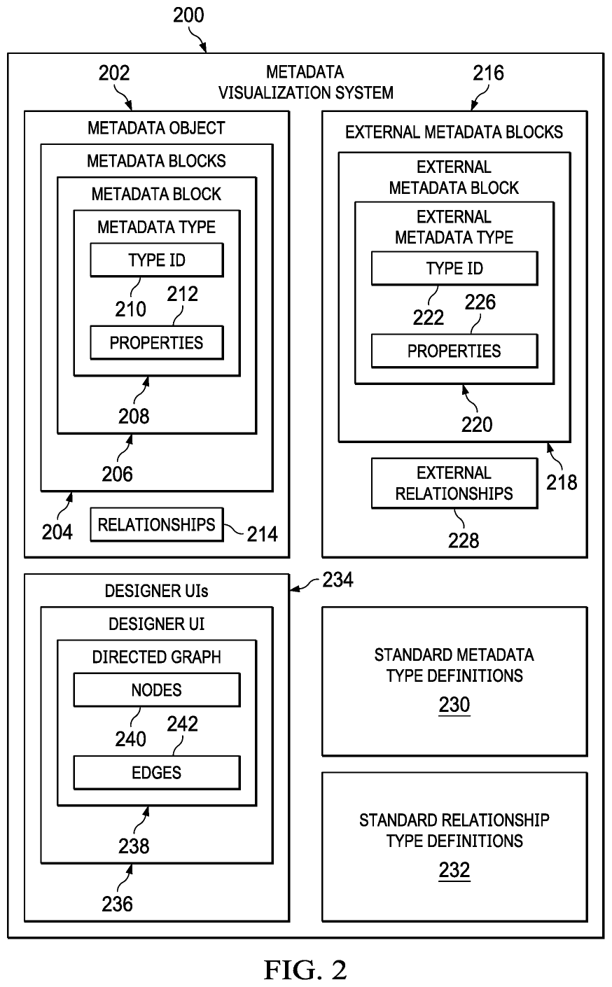

Turning to FIG. 2, a block diagram of a metadata visualization system is depicted in accordance with an illustrative embodiment. Metadata visualization system 200 might be implemented in network data processing system 100 shown in FIG. 1.

Metadata visualization system 200 operates on metadata object 202. Metadata object 202 might comprise a number of metadata blocks (actions) 204. Each metadata block 206 in metadata blocks 204 has a metadata type 208 that includes a type ID 210 and properties 212 of that type. Metadata object 202 also comprises relationships 214 between the metadata blocks 204.

One or more metadata blocks 204 in metadata object 202 might comprise a reference to a number of external metadata blocks 216. Each external metadata block 218 comprises an external metadata type 220 with its respective type ID 222 and properties 224.

Metadata visualization system 200 comprises a number of designer user interfaces (UI) 234 in which metadata blocks 204 and external metadata blocks 216 can be opened. A designer UI 236 is a UI that can create metadata instances. Each designer is bound to a metadata type definition, and every metadata instance belongs to a certain type definition. The metadata architecture provides functionality to create and manage multiple type definitions, through which developer teams can create different designers in the framework.

Typically, differences between the external metadata type 220 and metadata type 208 and difference between external relationships 228 and relationships 214 require external metadata blocks 216 to be viewed in different designer UIs 234 than metadata blocks 204.

Metadata visualization system 200 includes standard metadata type definitions 230 to which metadata type 208 and external metadata type 220 can be mapped, thereby providing a common denominator so to speak that is not specific to particular designer UIs 234. Similarly, metadata visualization system 200 includes standard relationship type definitions 232 to which relationships 214 and external relationships 2228 can be mapped.

Standard metadata type definitions 230 and standard relationship type definitions 232 allow metadata blocks 204 and external metadata blocks 216 to be viewed in a common designer UI 236 and combined in a common directed graph 238. Directed graph 238 might comprise nodes 240 representing standardized metadata blocks and edges 242 representing standardized relationships.

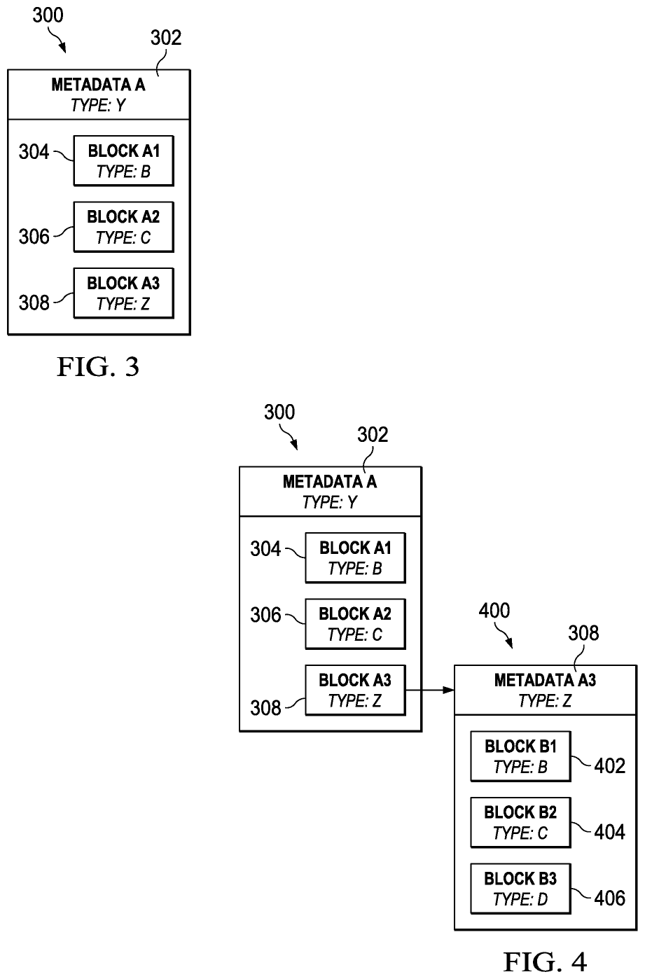

FIG. 3 illustrates an example metadata object with which illustrative embodiments can be implemented. Metadata object 302 might be an example of metadata object 202 in FIG. 2. Metadata object 302 is shown in designer UI 300, which might be an example of designer UI 236 in FIG. 2. Stated simply, metadata is information about other data that describes one or more aspects of the data. Metadata allows a system to track and work with the data in question more easily. Metadata object 302 might be used by any of server computers 104, 106 or client devices 110 shown in FIG. 1.

Metadata object 302 can be defined as an operation containing groups of actions. Metadata object 302 can have a specified type (i.e. Type Y). Metadata object 300 might also contain a number of children called “blocks,” e.g., 304, 306, 308 that can be opened in designer UI 300. A block is the smallest unit that can represent an action specified by a developer.

Each of blocks 304, 306, 308 in turn can have respective types. A type definition defines blocks and the properties and relationships between the blocks. In the present example block 304 is Type B, block 306 is Type C, and block 308 is Type Z.

FIG. 4 illustrates an example of complex metadata with which illustrative embodiments can be implemented. Metadata with no external metadata might be referred to as simple metadata. Metadata with one or more external metadata blocks might be referred to as complex metadata. A simple metadata object is easier to understand because the whole representation of the actions (blocks) are present in one designer interface.

In the present example, the architecture of metadata object 302 includes metadata block 308, which references external metadata blocks 402, 404, and 406 that cannot be opened in designer UI 300. For complex metadata, each external metadata block reference has to be opened in an external designer (e.g., 400). Designer UI 400 expands the references in metadata block 308 to show external metadata blocks 402, 404, 406.

As a result, complex metadata can be difficult to visualize because multiple designers have to be used, requiring developers to switch back and forth between browser tabs to understand each external block. To make it easier for developers to understand the whole flow of operations across the entire metadata, the illustrative embodiments provide a simplified way of representing the flow of actions (blocks), which is not achievable with any of the current designers since not all designer UI support all block types.

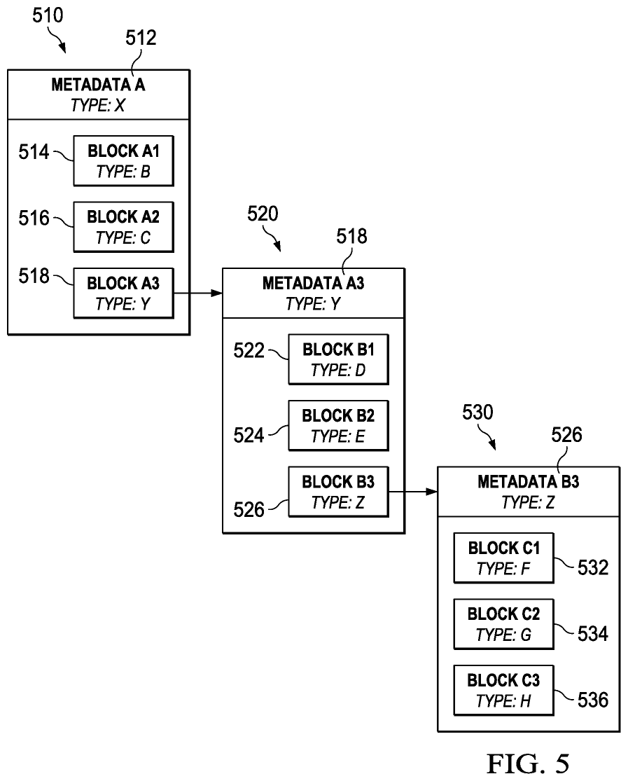

FIG. 5 illustrates expanded external metadata blocks in accordance with an illustrative embodiment. In a metadata structure typical of the prior art, external metadata blocks are present merely as a reference, meaning only the global unique identifier (GUID) of the external metadata is used as a reference. The illustrative embodiments replace the GUID of an external metadata references with the actual metadata blocks. This process begins by recursively expanding all external metadata block references as shown in FIG. 5.

In the example shown in FIG. 5, metadata object 512 in designer 510 comprises metadata blocks 514, 516, and 518. Metadata block 518 references blocks 522, 524, and 526.

Designer 520 expands the reference of block 518 to show external blocks 522, 524, and 526, similar to the example shown in FIG. 4. In this example, block 526 in turn references external metadata blocks 532, 534, 536 that have to be opened in yet another designer 530.

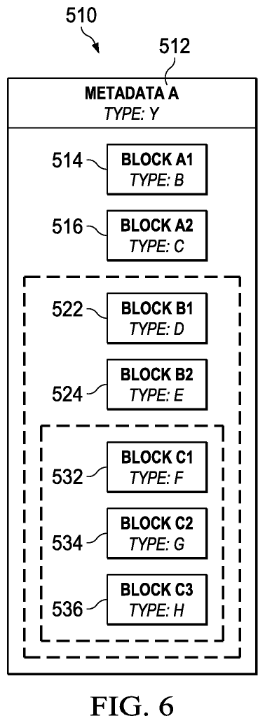

FIG. 6 illustrates linked metadata blocks in accordance with an illustrative embodiment. After all external metadata blocks are expanded, the blocks are linked together as a single object.

Using the example in FIG. 5, block 518 in metadata object 512 is replaced with external metadata blocks 522, 524, and 526 which block 518 references. In turn, block 526 is replaced with external metadata blocks 532, 534, and 536, which block 526 references. Although expanding and linking metadata blocks creates a unified metadata, it is still not in a representable state because not all the designers support every block type.

For a given metadata, different designers will create different data for the same operation because the designers use different type definitions. The differences might manifest themselves as different type IDs, different names of properties, and the ways in which blocks are connected. These differences make it difficult if not impossible to write a common logic to plot the metadata visualization.

Therefore, the illustrative embodiments employ standard block types to which different block types can be mapped (e.g., standard metadata type definitions 230).

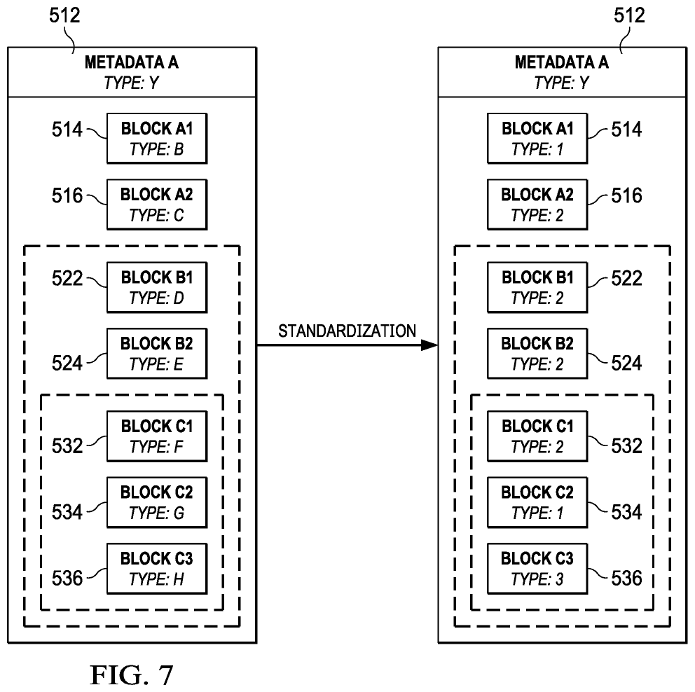

FIG. 7 illustrates standardization of metadata blocks in accordance with an illustrative embodiment. Standardization comprises defining block types that are generic and not tied to any specific designer. Different metadata types can be mapped to these predefined standard metadata types.

As shown in FIG. 7, the metadata blocks 512, 514, 522, 524, 532, 534, 536 remain the same during standardization, but their respective metadata types are converted to standard types. In the present example, Types B and G are mapped to standard Type 1. Similarly, Types C, D, E, and F are mapped to standard Type 2. Type H is mapped to standard Type 3.

After metadata block types are standardized, the relationships of the blocks to each other are still different across the different metadata types. Therefore, the illustrative embodiments can employ a list of standard relationship types (e.g., standard relationship types 232) that are generic and can be applied to all designer types. Similar to the standard block types described above, each relationship between metadata blocks can be mapped to a predefined standard relationship type.

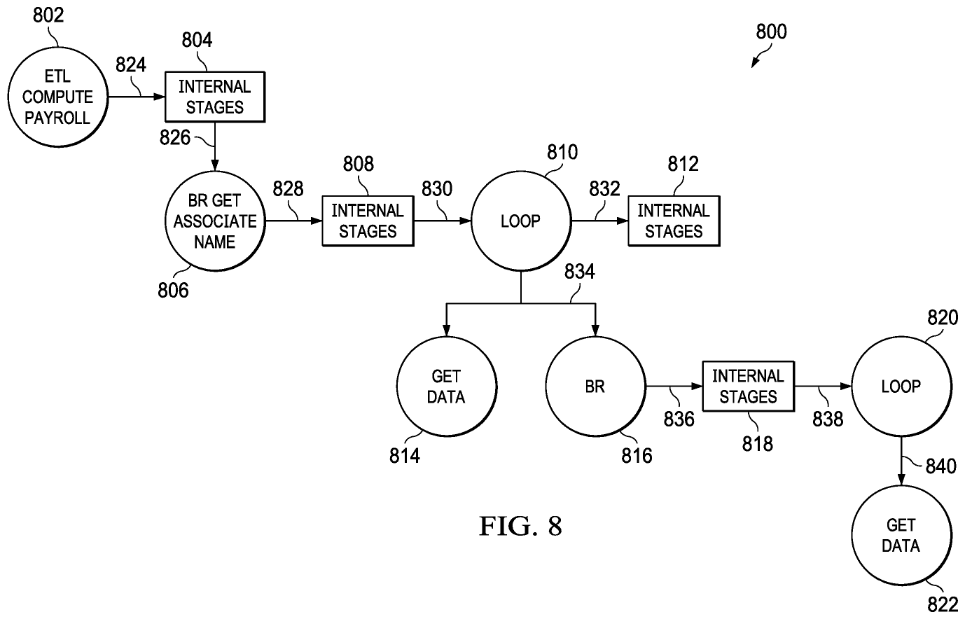

FIG. 8 depicts a directed graph illustrating standard metadata block types and standard relationship types in accordance with an illustrative embodiment. To take complete advantage of the unified metadata, the illustrative embodiments store the metadata in a data structure that enables different operations to be performed at a high speed and cost effectively. The data structure for this framework might be a directed graph such as directed graph 800.

Directed graph 800 contains nodes 802-822 and edges 824-840. The nodes 802-822 represent the metadata blocks, and the edges 824-840 represent the relationships between the blocks. The code for generating the directed graph 800 is based on a standard format. This standard format can be considered a standard type definition. Therefore, the nodes 802-822 in directed graph 800 belong to standard metadata block types, and the edges 824-840 are standard relationship types.

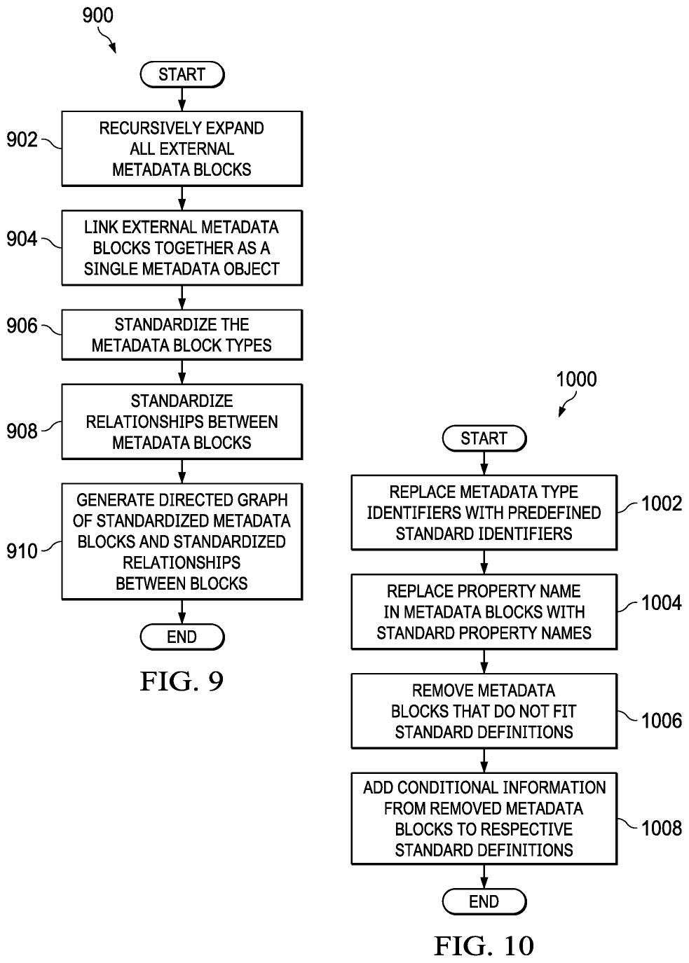

FIG. 9 depicts a flowchart illustrating a process for visualizing metadata in accordance with an illustrative embodiment. Process 900 might be implements using metadata visualization system 200 shown in FIG. 2 using metadata objects and block such as those shown in FIGS. 3-8.

Process 900 begins by recursively expanding all external metadata blocks in a metadata object (step 902). The external metadata blocks might comprise different metadata types. Expanding the external metadata blocks might comprise replacing a GUID for each metadata block with the actual metadata block referenced by the GUID.

After expanding the external metadata blocks, the external metadata blocks are linked together as a single metadata object (step 904).

All metablocks are then standardized, wherein the different metadata types are mapped to predefined standard metadata types (step 906). After standardizing the metadata blocks, all the metadata blocks can be represented in a common user interface. The relationship types between the metadata blocks are then standardized, wherein different relationship types are mapped to a predefined standard relationship type (step 908).

A directed graph comprising a number of nodes and edges is generated, wherein each node represents a standardized metadata block and each edge represents a standardized relationship type (step 910). Process 900 then ends.

FIG. 10 depicts a flowchart illustrating a process for standardizing metadata types in accordance with an illustrative embodiment. Process 1000 might be a more detailed example of step 906 in FIG. 9.

Process 900 begins by replacing metadata type identifiers for the metadata blocks with equivalent predefined standard type identifiers (step 1002). The property names in the metadata blocks are replaced with equivalent predefined standard property names (step 1004).

Metadata blocks that do not fit a predefined standard type definition are removed (step 1006). Conditional information (e.g., “if,” “else,” etc.) from removed metadata blocks is then added into respective predefined standard type definitions to which they correspond (step 1008). Process 1000 then ends.

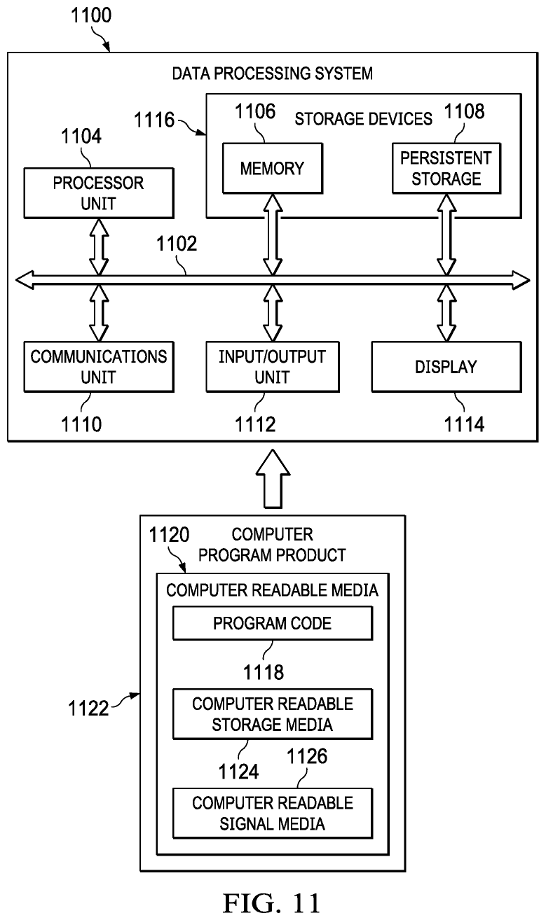

Turning now to FIG. 11, an illustration of a block diagram of a data processing system is depicted in accordance with an illustrative embodiment. Data processing system 1100 may be used to implement one or more computers, including server computers 104, 106 and client devices 110 in FIG. 1. In this illustrative example, data processing system 1100 includes communications framework 1102, which provides communications between processor unit 1104, memory 1106, persistent storage 1108, communications unit 1110, input/output unit 1112, and display 1114. In this example, communications framework 1102 may take the form of a bus system.

Processor unit 1104 serves to execute instructions for software that may be loaded into memory 1106. Processor unit 1104 may be a number of processors, a multi-processor core, or some other type of processor, depending on the particular implementation. In an embodiment, processor unit 1104 comprises one or more conventional general-purpose central processing units (CPUs). In an alternate embodiment, processor unit 1104 comprises one or more graphical processing units (CPUs).

Memory 1106 and persistent storage 1108 are examples of storage devices 1116. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1116 may also be referred to as computer-readable storage devices in these illustrative examples. Memory 1116, in these examples, may be, for example, a random access memory or any other suitable volatile or non-volatile storage device. Persistent storage 1108 may take various forms, depending on the particular implementation.

For example, persistent storage 1108 may contain one or more components or devices. For example, persistent storage 1108 may be a hard drive, a flash memory, a rewritable optical disk, a rewritable magnetic tape, or some combination of the above. The media used by persistent storage 1108 also may be removable. For example, a removable hard drive may be used for persistent storage 1108. Communications unit 1110, in these illustrative examples, provides for communications with other data processing systems or devices. In these illustrative examples, communications unit 1110 is a network interface card.

Input/output unit 1112 allows for input and output of data with other devices that may be connected to data processing system 1100. For example, input/output unit 1112 may provide a connection for user input through at least one of a keyboard, a mouse, or some other suitable input device. Further, input/output unit 1112 may send output to a printer. Display 1114 provides a mechanism to display information to a user.

Instructions for at least one of the operating system, applications, or programs may be located in storage devices 1116, which are in communication with processor unit 1104 through communications framework 1102. The processes of the different embodiments may be performed by processor unit 1104 using computer-implemented instructions, which may be located in a memory, such as memory 1106.

These instructions are referred to as program code, computer-usable program code, or computer-readable program code that may be read and executed by a processor in processor unit 1104. The program code in the different embodiments may be embodied on different physical or computer-readable storage media, such as memory 1106 or persistent storage 1108.

Program code 1118 is located in a functional form on computer-readable media 1120 that is selectively removable and may be loaded onto or transferred to data processing system 1100 for execution by processor unit 1104. Program code 1118 and computer-readable media 1120 form computer program product 1122 in these illustrative examples. In one example, computer-readable media 1120 may be computer-readable storage media 1124 or computer-readable signal media 1126.

In these illustrative examples, computer-readable storage media 1124 is a physical or tangible storage device used to store program code 1118 rather than a medium that propagates or transmits program code 1118. Alternatively, program code 1118 may be transferred to data processing system 1100 using computer-readable signal media 1126.

Computer-readable signal media 1126 may be, for example, a propagated data signal containing program code 1118. For example, computer-readable signal media 1126 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1100 are not meant to provide architectural limitations to the manner in which different embodiments may be implemented. The different illustrative embodiments may be implemented in a data processing system including components in addition to or in place of those illustrated for data processing system 1100. Other components shown in FIG. 11 can be varied from the illustrative examples shown. The different embodiments may be implemented using any hardware device or system capable of running program code 1118.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method of visualizing metadata, the method comprising:
using a number of processors to perform the steps of:
recursively expanding all external metadata blocks in a metadata object, wherein the external metadata blocks comprise different metadata types;
standardizing all metadata blocks, wherein the different metadata types are mapped to predefined standard metadata types;
standardizing relationship types between the metadata blocks, wherein different relationship types are mapped to a predefined standard relationship type; and
generating a directed graph comprising a number of nodes and edges, wherein each node represents a standardized metadata block and each edge represents a standardized relationship type.

2. The method of claim 1, wherein expanding the external metadata blocks comprises replacing a global unique identifier for each metadata block with an actual metadata block referenced by the global unique identifier.

3. The method of claim 1, further comprising, after expanding the external metadata blocks, linking the external metadata blocks together as a single metadata object.

4. The method of claim 1, wherein, after standardizing the metadata blocks, all the metadata blocks can be represented in a common user interface.

5. The method of claim 1, wherein standardizing the metadata blocks further comprises replacing metadata type identifiers for the metadata blocks with equivalent predefined standard type identifiers.

6. The method of claim 5, further comprising replacing property names in the metadata blocks with equivalent predefined standard property names.

7. The method of claim 6, further comprising removing metadata blocks that do not fit a predefined standard type definition.

8. The method of claim 7, further comprising adding conditional information from removed metadata blocks into respective predefined standard type definitions to which they correspond.

9. A computer program product for visualizing metadata, the computer program product comprising:
a computer-readable storage medium having program instructions embodied thereon to perform the steps of:
recursively expanding all external metadata blocks in a metadata object, wherein the external metadata blocks comprise different metadata types;
standardizing all metadata blocks, wherein the different metadata types are mapped to predefined standard metadata types;
standardizing relationship types between the metadata blocks, wherein different relationship types are mapped to a predefined standard relationship type; and
generating a directed graph comprising a number of nodes and edges, wherein each node represents a standardized metadata block and each edge represents a standardized relationship type.

10. The computer program product of claim 9, wherein expanding the external metadata blocks comprises replacing a global unique identifier for each metadata block with an actual metadata block referenced by the global unique identifier.

11. The computer program product of claim 9, further comprising instructions for, after expanding the external metadata blocks, linking the external metadata blocks together as a single metadata object.

12. The computer program product of claim 9, wherein, after standardizing the metadata blocks, all the metadata blocks can be represented in a common user interface.

13. The computer program product of claim 9, wherein standardizing the metadata blocks further comprises instructions for replacing metadata type identifiers for the metadata blocks with equivalent predefined standard type identifiers.

14. The computer program product of claim 13, further comprising instructions for replacing property names in the metadata blocks with equivalent predefined standard property names.

15. The computer program product of claim 14, further comprising instructions for removing metadata blocks that do not fit a predefined standard type definition.

16. The computer program product of claim 15, further comprising instructions for adding conditional information from removed metadata blocks into respective predefined standard type definitions to which they correspond.

17. A system visualizing metadata, the system comprising:
a storage device configured to store program instructions; and
one or more processors operably connected to the storage device and configured to execute the program instructions to cause the system to:
recursively expand all external metadata blocks in a metadata object, wherein the external metadata blocks comprise different metadata types;
standardize all metadata blocks, wherein the different metadata types are mapped to predefined standard metadata types;
standardize relationship types between the metadata blocks, wherein different relationship types are mapped to a predefined standard relationship type; and
generate a directed graph comprising a number of nodes and edges, wherein each node represents a standardized metadata block and each edge represents a standardized relationship type.

18. The system of claim 17, wherein expanding the external metadata blocks comprises replacing a global unique identifier for each metadata block with an actual metadata block referenced by the global unique identifier.

19. The system of claim 17, wherein the processors further execute instructions to, after expanding the external metadata blocks, link the external metadata blocks together as a single metadata object.

20. The system of claim 17, wherein, after standardizing the metadata blocks, all the metadata blocks can be represented in a common user interface.
